(19) United States
(12) Patent Application Publication
(10) Pub. No.: US 2025/0099974 A1
(43) Pub. Date: Mar. 27, 2025

(54) GLASS POWDER PRODUCTION PROCESS AND GLASS POWDER PRODUCTION DEVICE

(71) Applicants: Anthony Cialone, Naples, FL (US); Josef Fischer, Bobingen (DE); Chris Fischer, Bobingen (DE)

(72) Inventors: Josef Fischer, Bobingen (DE); Chris Fischer, Bobingen (DE)

(21) Appl. No.: 18/819,795

(22) Filed: Aug. 29, 2024

(30) Foreign Application Priority Data
Sep. 22, 2023 (EP) 23 199 152.2

(51) Int. Cl. B02C 23/32; B02C 21/00

(52) U.S. Cl. CPC B02C 23/32; B02C 21/00; B02C 2201/00

(57) ABSTRACT

A glass powder production process for producing glass powder with a grain size <40 μm includes feeding a fine mill with glass cullet and dry grinding the glass cullet in the fine mill, feeding the crushed glass cullet into an air classifier and air classifying the crushed glass cullet into a fine material fraction and a coarse material fraction, wherein the separation limit of the air classifier is set to a grain size <40 μm, discharging the coarse material fraction from the air separator, preparing the coarse material fraction for refeeding into the fine mill, refeeding the coarse material fraction into the fine mill, outputting the fine material fraction as the end product, the glass powder. The disclosure also relates to a glass powder production device suitable for carrying out the process.

### CROSS REFERENCE TO RELATED APPLICATIONS

This application claims priority to European patent application EP 23 199 152.2, filed Sep. 22, 2023, the entire content of which is incorporated herein by reference.

### TECHNICAL FIELD

The disclosure relates to a glass powder production process and a glass powder production device.

### BACKGROUND

In the course of the infrastructure investments that have become increasingly necessary in industrialized countries in recent years, it has become apparent that concrete structures from more recent times often wear out after relatively short periods of time, whereas the ancient Pantheon in Rome, for example, has lasted for thousands of years. For this reason, attempts are being made in modern times to give concrete and cement pozzolanic properties, just as the ancient Romans did.

Fly ash is often used as a pozzolanic additive for concrete or cement. Fly ash consists of spherical particles that have a favorable influence on the grain distribution in concrete for workability and, as a pozzolanic feature, bring about additional structural compaction in hardening concrete, which runs off slowly and thus gives the concrete a long service life. Fly ash is produced as combustion residue in coal-fired power plants and will therefore be available to a lesser extent in the future than it is today as part of the energy transition.

Recent tests have shown that finely ground glass powder can be used as a substitute pozzolan for fly ash, wherein the fineness of the glass powder not only has a favorable effect on the workability of concrete, but also results in higher strength with lower weight and better flowability for filling cavities. However, the glass powder available to date has a relatively coarse-grained structure. Grinding the glass in wet ball mills, which are usually equipped with rotating metal balls, also results in high reject rates of coarse particles, which have to be laboriously separated from the end product and disposed of after grinding, which is possible under laboratory conditions, but makes large-scale industrial implementation difficult.

German patent application DE 196 33 257 C1 discloses a process for the production of porous glass in the form of glass powder, in which a pre-comminuted base glass is ground dry on a jet mill and then classified into a coarse material fraction and a fine material fraction using an air classifier. A corresponding process is disclosed in the international patent application WO 2007/098778 A1.

According to US patent application US 2008/0308659 A1, it is proposed for pozzolan production to carry out the grinding of the glass cullet dried on a ball mill, wherein the ground glass cullet is then classified into a coarse material fraction and a fine material fraction and the coarse material fraction is returned to the ball mill.

### SUMMARY

It is therefore an object of the present disclosure to provide a glass powder production process and a glass powder production device with which a glass powder of fine grain size can be produced with high efficiency.

This object is achieved by the glass powder production process and the glass powder production device as described herein.

According to the disclosure, a glass powder production process and a device for carrying out this process are proposed, with which glass powder with a grain size <40 μm or even 15 μm to 25 μm, preferably <20 μm, is produced. It has been shown that, despite the highly abrasive glass cullet to be processed, dry grinding can be carried out on a fine mill and produces a high proportion of fine particles in the ground glass cullet. This offers the additional advantage that the classification of the ground glass cullet into a fine material fraction serving as the end product glass powder and a coarse material fraction to be separated from the end product can be carried out on a downstream air classifier. The fine mill to be fed with the glass cullet can be a jet mill, an impact disk mill or, as has been found to be particularly advantageous, a vortex mill, on which the dry grinding of the glass cullet then takes place.

Impact disk mills have two almost vertical grinding disks rotating around a horizontal axis, between which the material to be ground is fed and extracted from the grinding chamber after grinding.

In jet mills, particles are ground in a gas stream without the use of mechanical tools such as high-speed rotors. The particles are crushed using the energy introduced by the grinding gas. As a rule, a cyclone separator is provided after the mill to separate the grinding gas from the grinding dust. In jet mills or fluidized bed counter-jet mills, a subspecies of jet mills, the bulk material to be ground is fed to a grinding feed and from there enters a grinding area around which compressed air nozzles are arranged, the compressed air jets of which capture the fed bulk material particles and accelerate them in a concentric direction so that they collide with each other and are ground in the process.

Vortex mills are known, for example, from patent EP 0 787 528 B1 and have a grinding gap defined between a stator and a rotor. Vortex mills work according to the principle of the impact mill with a vertically arranged rotor and a stator surrounding the rotor on the radial side. The stator usually has a truncated cone-shaped grinding path with an inwardly directed corrugation running in the axial direction, i.e., vertically, which is usually fixed in a housing of the vortex mill. On the other side of the grinding gap, on the inside, is the rotor, which can be driven at high speed and is equipped with one or usually a plurality of so-called grinding rings along the axial direction, on which grinding tools are mounted. If the rotor now rotates at high speed in the stator, with the axis of rotation extending in the vertical direction, and material to be ground is fed from above and centrifuged outwards in a gap between the rotor and a cover of the housing and from there into the grinding gap, this material is ground between the corrugation of the grinding path and the grinding tools, in which the individual particles are thrown back and forth between the grinding path and grinding tools more or less often, depending on the material density and grain size, and are broken or crushed on impact.

Air classifiers are described, for example, in German patent DE 3 303 078 C1 and in German patent application DE 10 2005 001 542 A1 and are used to separate a coarse material fraction from a fine material fraction from a heterogeneous mixture of different grain sizes. For this purpose, air classifiers have one or more classifier wheels arranged above a classifying chamber, wherein the particles of the material to be classified are entrained in the classifying chamber by an upward air flow or, if the particle is too heavy, are not entrained. Of the light particles that reach the classifier wheel, only those particles that are smaller than the upper grain limit defined by the classifier wheel can pass through the classifier wheel. The others fall back.

According to the disclosure, a fine mill and preferably a vortex mill is now combined with a downstream air classifier in order to produce glass powder with said grain size. The relatively fuzzy separation limit of air classifiers must be taken into account, so that the specification of a grain size of <20 μm cannot be understood to be accurate to one μm.

It should be noted that such vortex mill-air classifier combinations are also already known per se, see German patent DE 10 2013 002 237 B3. What is surprising, however, is that the use of such a vortex mill-air classifier combination as a glass powder production device for carrying out the glass powder production process according to the disclosure results in significantly larger fine material fractions compared to glass grinding on wet ball mills, especially for the particularly desirable glass particles with grain sizes below 20 μm.

Further according to the disclosure, the coarse material fraction discharged is fed back into the fine mill and thus subjected again to the grinding process and subsequent air classifying, so that ultimately a much smaller residue that cannot be ground to the desired grain size is obtained. However, it has been found that returning the coarse material fraction to the fine mill in the air classifier state results in a long process duration and thus a grinding and classifying process for glass powder production that requires further improvement in terms of efficiency. Further in accordance with the disclosure, the coarse material fraction is therefore prepared for refeeding before being fed back into the fine mill. In this context, processing can mean further grinding, low-temperature embrittlement, taking out particularly large particles by classification or the like.

The further subclaims relate to advantageous further developments of the glass powder production process according to the disclosure, or of the glass powder production device according to the disclosure.

It has proven to be particularly advantageous if the coarse material fraction is processed by wet grinding the coarse material fraction on a wet mill, for example a wet ball mill, and then drying the wet-ground coarse material fraction before the wet-ground and re-dried coarse material fraction is fed back into the fine mill. This is because it has been shown that refeeding the wet-ground and dried material not only enables the glass cullet to be completely or almost completely recycled for the production of fine-grained glass powder, but also makes the grinding process extremely efficient in terms of the time and energy required.

This is particularly surprising in terms of energy consumption, because drying the wet-ground coarse material is relatively energy-intensive. This is because, according to an advantageous further development, a hot gas stream is generated for this purpose, which is used to dry the wet-ground coarse material fraction and, in order to avoid contamination, also the fed glass cullet before it is fed into the vortex mill or fine mill. However, this hot gas flow can be generated in a virtually CO2-neutral and cost-effective manner by means of a wood powder burner, a modified oil burner for burning wood flour, if the wood powder burner is preceded by a further fine mill, in particular a further vortex mill, which is used to grind wood waste into wood flour.

### BRIEF DESCRIPTION OF THE DRAWINGS

The disclosure will now be described with reference to the drawings wherein:

FIG. 1 shows a schematic diagram of a glass powder production device according to a preferred embodiment of the disclosure.

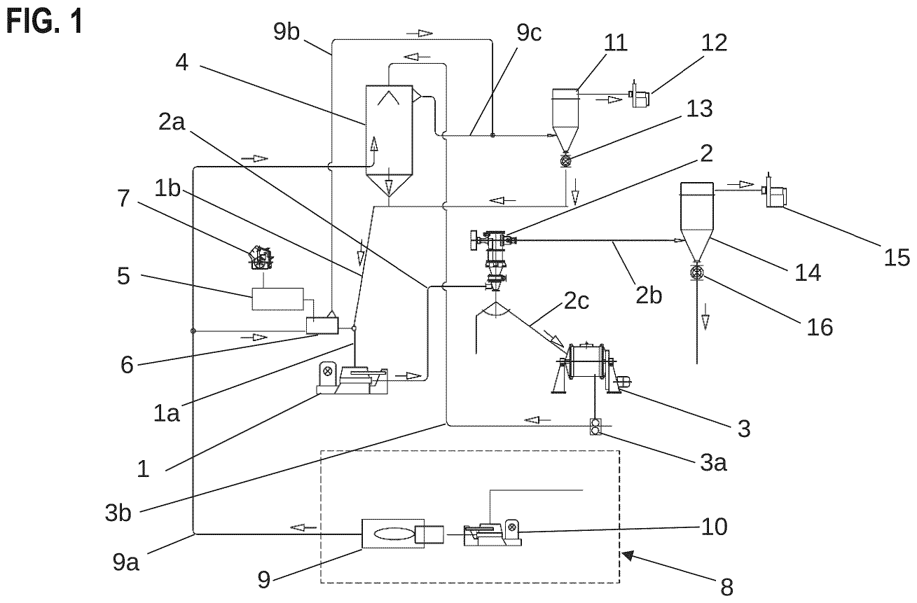

### DESCRIPTION OF EXEMPLARY EMBODIMENTS

Reference number 1 refers to a fine mill, namely a vortex mill, which is preceded by a coarse crushing device 7 serving simultaneously as a glass cullet feeder, a washing system 5 for the fed and coarsely crushed glass cullet, and a dryer 6 for the coarsely crushed and washed glass cullet. The coarse crushing device can, for example, be a hammer mill or similar. The dryer, on the other hand, can be designed as a rotating drum through which a stream of (hot) air flows.

The ground material leaves the vortex mill 1 via a feed line serving as a feed device 2a into an air classifier 2, in which the ground material is divided into a fine material fraction and a coarse material fraction. If necessary, the feed device 2a could also include conveying blowers or the like. The fine material fraction passing through the classifier wheel of the air classifier 2 is conveyed via a further air flow line 2b into a filter system 14, for example a cyclone separator or vapor filter, with a connected exhaust air extraction fan 15 and a rotary valve serving as a residual particle discharge 16. The line 2b, the filter system 14, the exhaust fan 15 and the rotary valve 16 thus form an output device 2b, 14, 15, 16 for removing/outputting product produced with the glass powder production process or the glass powder production device according to the preferred embodiment of the disclosure, namely the glass powder with a grain size that is <40 μm, in particular <15 μm to 25 μm and preferably <20 μm.

The coarse material discharged in the air classifier 2 passes through the coarse material discharge rotary valve of the air classifier 2 or a similar mechanism such as a coarse material discharge screw and a downpipe 2c, which together form a coarse material discharge device 2c for discharging the coarse material from the air classifier 2, into a wet mill, in this case a wet ball mill 3. There, the coarse material fraction discharged from the air classifier 2 is wet-ground and then fed to a drying system designed as a spray drying tower 4, from where it is fed back into the vortex mill 1. The wet ball mill 3 and the spray drying tower 4 thus form a coarse material processing device 3, 4 for processing the coarse material fraction before it is fed back into the vortex mill 1.

A liquid line 3b leads from the outlet of the wet ball mill 3 to an inlet on the upper side of the spray drying tower 4, via which the slurry consisting of the wet-ground coarse material fraction is conveyed from the wet ball mill 3 into the spray drying tower 4 by means of a feed pump 3a or the like. A downpipe 1b is connected to the bottom outlet of the spray drying tower 4, which opens into an inlet-side downpipe 1a at the inlet of the vortex mill 1, through which the starting material, namely the glass cullet, is also fed to the vortex mill 1. The feed pump 3a, the feed line 3b and the downpipe 1b thus form a refeeding device 3a, 3b, 1b for refeeding the processed, i.e. wet ground and dried coarse material fraction into the vortex mill 1.

The wet-ground coarse material fraction is dried in the spray drying tower 4 by means of a hot air flow introduced in the lower area of the spray drying tower 4, which flows upwards in the spray drying tower 4 to an air outlet in the upper area of the spray drying tower 4. The slurry coming from the wet ball mill 3 is injected into this hot air flow via a nozzle arrangement provided at the top inlet of the spray tower 4, which then dries as it falls against the hot air flow towards the bottom outlet of the spray drying tower 4. The hot air flow loaded with water vapor is then fed to a vapor filter 11 via a vapor line 9c connected to the air outlet of the spray drying tower 4, which is extracted by means of an extraction fan 12, wherein the residual glass particles separated in the vapor filter can optionally also be returned to the vortex mill 1 via a rotary valve on the underside and a connecting line connected to the downpipe 1b.

To generate the hot air or gas flow supplied to the spray drying tower 4, a hot gas flow generating device designated with numeral 8 is provided, which comprises a wood powder burner 9, which is fed with wood powder by a further fine mill 10, which further fine mill 10, designed as a vortex mill, grinds wood waste, plywood or the like.

A hot gas line 9a, which leads from the wood burner 9 to the air inlet of the spray drying tower 4 and has a branch that opens at the dryer 6, serves as the hot gas feed device 9a for introducing the hot gas flow generated at the wood burner 9 into the spray drying tower 4 and the dryer 6. On the air outlet side, the dryer 6 is connected to the vapor filter 11 via a further vapor line 9b.

Variations and modifications of the embodiment shown are possible without departing from the scope of the disclosure.

For example, it would be conceivable to use the warm air extracted from the vapor filter 11 by the extraction fan 12 to preheat the air to be fed to the wood burner.

What is claimed is:

1. A glass powder production process for producing glass powder with a grain size <40 μm, in particular <15 μm to 25 μm, preferably <20 μm, comprising:
feeding a fine mill, namely a jet mill, impact disk mill, or preferably a vortex mill with glass cullet and dry grinding the glass cullet in the fine mill;
feeding the crushed glass cullet into an air classifier and air classifying the crushed glass cullet into a fine material fraction and a coarse material fraction, wherein the separation limit of the air classifier is set to a grain size <40 μm, in particular a grain size of <15 μm to 25 μm, preferably <20 μm;
discharging the coarse material fraction from the air classifier;
preparing the coarse material fraction for refeeding into the fine mill;
refeeding the coarse material fraction into the fine mill; and
outputting the fine material fraction as the end product, the glass powder.

2. The glass powder production process according to claim 1, wherein the preparation of the coarse material fraction is carried out by wet grinding of the coarse material fraction and subsequent drying of the wet-ground coarse material fraction before the coarse material fraction is fed back into the fine mill.

3. The glass powder production process according to claim 2, wherein the drying of the wet-ground coarse material fraction takes place in a spray drying tower, in which the wet-ground coarse material fraction is injected in the upper region into a stream of air or gas coming from below and then exits in the lower region.

4. The glass powder production process according to claim 1, wherein the glass cullet is washed and dried before being fed to the fine mill.

5. The glass powder production process according to claim 2, wherein a hot gas stream is generated with which the wet-ground coarse material fraction and/or the washed glass cullet is dried.

6. The glass powder production process according to claim 5, wherein the hot gas stream is generated by means of a wood powder burner, which is preceded by a further fine mill, in particular a further vortex mill for grinding wood waste into wood powder.

7. The glass powder production device for producing glass powder with a grain size <μ40 m, in particular <15 μm to 25 μm, preferably <20 μm, comprising:
a fine mill for the dry grinding of glass cullet, namely a jet mill, impact disk mill, or preferably a vortex mill, with an upstream glass cullet feeder for feeding the fine mill with glass cullet;
an air classifier for classifying the ground glass cullet into a fine material fraction and a coarse material fraction, with a separation limit at a grain size <40 μm, in particular at a grain size of <15 μm to 25 μm, preferably <20 μm;
a feed device arranged between the air classifier and the fine mill for feeding the glass cullet ground on the fine mill into the air classifier;
a coarse material discharge device for discharging the coarse material fraction from the air classifier;
a coarse material preparation device for preparing the coarse material fraction for refeeding into the fine mill;
a refeeding device for refeeding the coarse material fraction into the fine mill; and
an output device arranged downstream of the air classifier for outputting the fine material fraction as the end product, the glass powder.

8. The glass powder production device according to claim 7, wherein the coarse material preparation device comprises a wet mill, in particular a wet ball mill, for wet grinding the coarse material fraction, and a downstream drying plant for drying the wet-ground coarse material fraction before it is fed back into the fine mill.

9. The glass powder production device according to claim 8, wherein the drying plant comprises a spray drying tower with a nozzle arrangement for injecting the wet-ground coarse material fraction in the upper region, an air inlet arrangement in the lower region, so that the wet-ground coarse material fraction is injected into the air or gas flow coming from below, and with a dry material outlet in the lower region for the dried, wet-ground coarse material fraction.

10. The glass powder production device according to one of claim 7, comprising a washing system for washing the glass cullet and a dryer for drying the washed glass cullet before feeding the fine mill with the washed and dried glass cullet.

11. The glass powder production device according to claim 9, comprising hot gas flow generating device for generating a hot gas flow, and hot gas feed device for introducing the hot gas flow into the spray drying tower and/or the dryer,
wherein the hot gas flow generating device preferably comprises a wood powder burner, which is preceded by a further fine mill, in particular a vortex mill for grinding wood waste into wood powder.
